(19) United States
(12) Patent Application Publication
(10) Pub. No.: US 2006/0119243 A1
(43) Pub. Date: Jun. 8, 2006

(54) Burner assembly

(76) Inventors: Andrew R. Lovvorn, Albany, OR (US); Jimmy Perez, Corvallis, OR (US); John W. Lee, Sweet Home, OR (US); David E. Huhn, Monmouth, OR (US); Robert C. Sattem, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/005,849

(22) Filed: Dec. 6, 2004

(51) Int. Cl. H01J 5/48; H01J 5/50

(52) U.S. Cl. 313/49

(57) ABSTRACT

A burner assembly includes a header, a burner coupled to the header, a holder coupled to the header, and a guard coupled to the holder, the guard being configured to at least partially surround the burner and to retract in response to coupling the burner to a reflector.

### BACKGROUND

Digital projectors, such as digital mirror devices (DMD) and liquid crystal display (LCD) projectors, project high quality images onto a viewing surface. Both DMD and LCD projectors utilize high-intensity burners and reflectors to generate the light needed for projection. Light generated by the burner is concentrated as a “fireball” that is located at a focal point of a reflector. This light is directed into a projection assembly that produces images and utilizes the generated light to form the image.

The image is then projected onto a viewing surface. Misalignment of the focal point causes degradation of the image, since less light is captured, and creates “hot spots” on the screen instead of a uniform brightness.

Efforts have been directed at making projectors more compact while making the image of higher and better quality. As a result, the burners utilized have become more compact and of higher intensity. Higher intensity burners produce high, even extreme heat. The outer surface of the burners can approach temperatures of 900° C. As a result, projector designs must account for the intense heat.

The intense heat generated by the burner may cause the burner to fail if contaminants such as oils or other contaminants are allowed to be deposited on the lamp. Such contaminants may include, for example, finger prints, that are deposited when users contact the lamp with their fingers.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 illustrates a schematic view of a display system according to one exemplary embodiment.

FIG. 2-1 illustrates a perspective view of a burner assembly with an external guard in an extended position according to one exemplary embodiment.

FIG. 2-2 illustrates a perspective view of the burner assembly of FIG. 2-1 in which the external guard is in an intermediate, partially retracted position according to one exemplary embodiment.

FIG. 2-3 illustrates a perspective view of the burner assembly of FIG. 2-1 in which the external guard is in a fully retracted position according to one exemplary embodiment.

FIG. 3-1 illustrates a schematic view of a lamp assembly that includes a burner assembly with an external guard as the burner assembly is in an initial position with respect to the reflector according to one exemplary embodiment.

FIG. 3-2 illustrates a schematic view of the lamp assembly of FIG. 3-1 in which the burner assembly is in an intermediate position with respect to the reflector.

FIG. 3-3 illustrates a schematic view of the lamp assembly of FIG. 3-1 in which the burner assembly is fully coupled to the reflector.

FIG. 4-1 illustrates a perspective view of a burner assembly with an internal guard in an extended position according to one exemplary embodiment.

FIG. 4-2 illustrates a perspective view of the burner assembly of FIG. 4-1 in which the internal guard is in an intermediate, partially retracted position according to one exemplary embodiment.

FIG. 4-3 illustrates a perspective view of the burner assembly of FIG. 4-1 in which the internal guard is in a fully retracted position according to one exemplary embodiment.

FIG. 5 illustrates a cross sectional view of the holder assembly of FIG. 4-3 taken along section A-A according to one exemplary embodiment.

FIG. 6 illustrates a schematic view of a lamp assembly that includes a burner assembly with an internal guard according to one exemplary embodiment.

Throughout the drawings, identical reference numbers designate similar, but not necessarily identical, elements.

### DETAILED DESCRIPTION

Several exemplary burner assemblies are provided herein that provide retraction or extension of guards that are coupled thereto. Such guards may reduce inadvertent contact with the burner and a user and/or other parts of the projector both before and after the burner assemblies are coupled to reflectors. In addition, the guard may protect the user from touching hot surfaces when removing the lamp, and provide protection of the glass surface for safe return of the assembly for recycling.

An exemplary display system will first be discussed, followed by a discussion of an exemplary burner assembly with an external guard, and then the interaction of the burner assembly and guard with an exemplary reflector. Thereafter, an exemplary internal guard will be discussed, followed by a discussion of the burner assembly and internal guard with another exemplary reflector.

In the following description, for purposes of explanation, numerous specific details are set forth in order to provide a thorough understanding of the present method and apparatus. It will be apparent, however, to one skilled in the art, that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Exemplary Display System

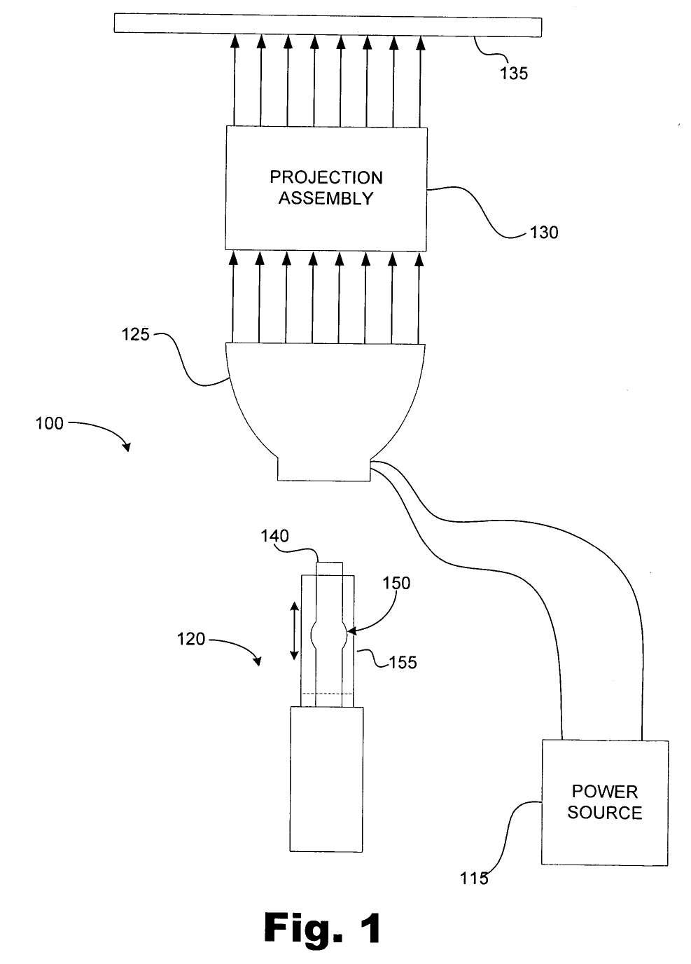

FIG. 1 is a schematic view of a display system (100). The display system (100) generally includes a power source (115), a burner assembly (120), a reflector (125), a light modulator or projection assembly (130), and a viewing surface (135). The burner assembly (120) is configured to be removably coupled to the reflector (125). The combination of the reflector (125) and the burner assembly (120) may be referred to as a lamp or lamp assembly.

The power source (115) is also coupled to the reflector (125). In particular, the power source (115) is coupled to the reflector (125) such that when the burner assembly (120) is also coupled to the reflector (125), the power source (115) is able to provide power to the burner assembly (120). The burner assembly (120) generates light when the burner assembly (120) receives power from the power source (115). The light the burner (140) generates is emitted as concentrated light from a central portion or fireball generator (150). This light is directed by the reflector (125) to the projection assembly (130). The projection assembly (130) modulates the light to form images that are projected onto the viewing surface (135).

In addition, the burner assembly (120) includes an integrated guard (155). The guard (155) is configured to protect the burner (140) from contact with the reflector (125) and/or contact by a user. In particular, the burner assembly (120) moves between an extended position, as shown by the solid line, to a retracted position, as shown by the dashed lines, when the burner assembly (120) is coupled to the reflector (125). As the guard (155) moves from the extended to the retracted position, the burner (120) is exposed and located with respect to the reflector (125).

Burner Assembly with External Guard

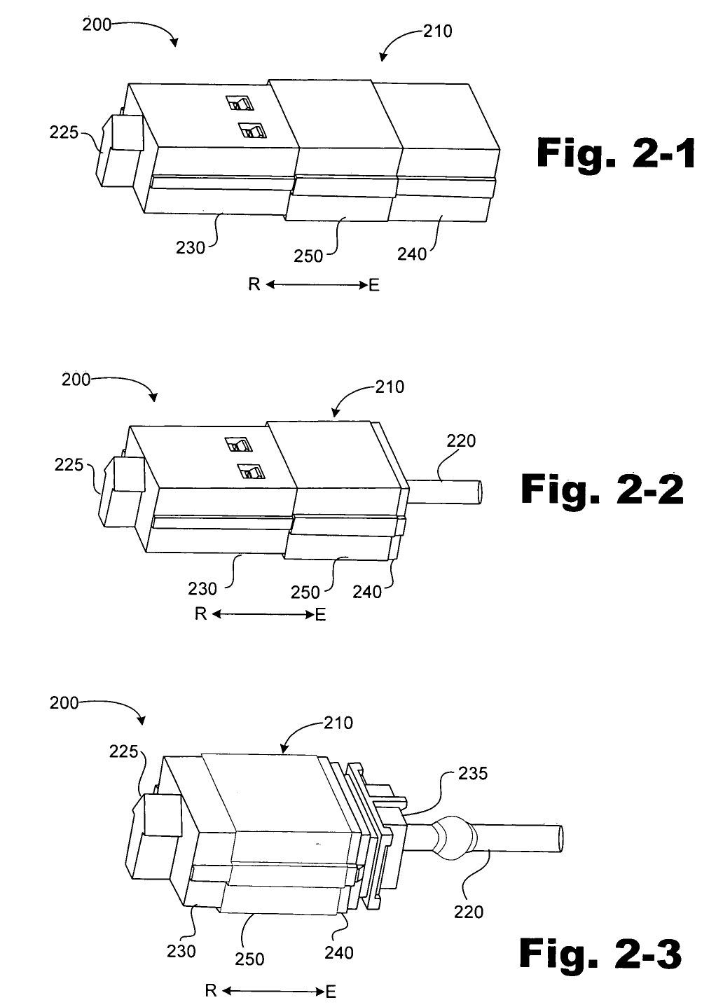

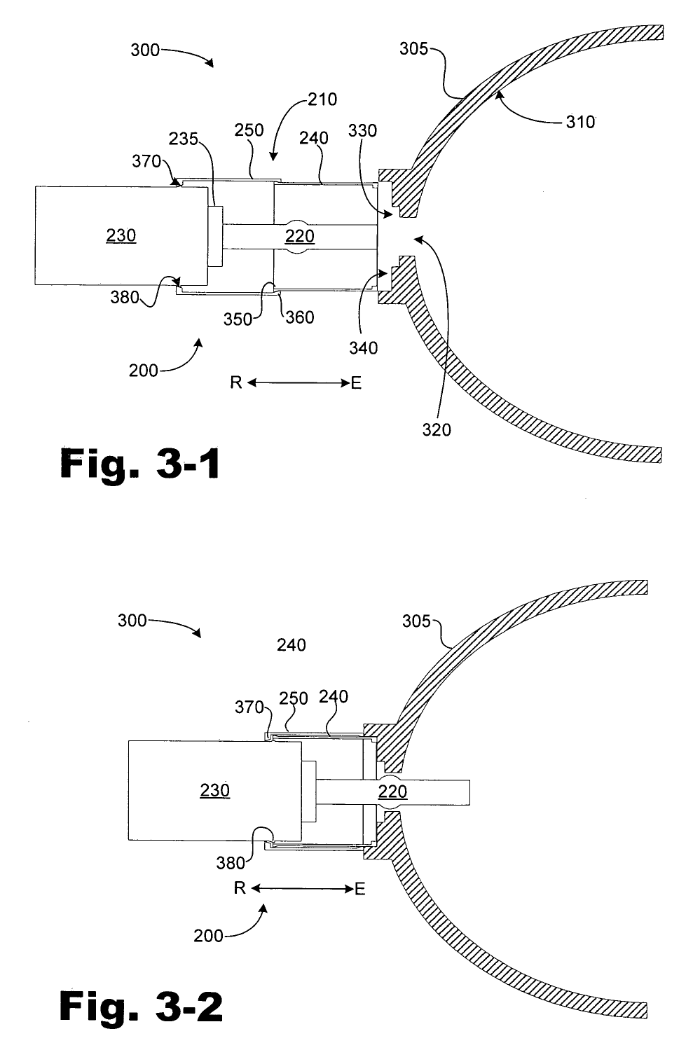

FIGS. 2-1, 2-2, and 2-3 illustrate perspective views of a burner assembly (200) in which an external guard (210) is shown in an extended position (FIG. 2-1), an intermediate or partially retracted position (FIG. 2-2) and a fully retracted position (FIG. 2-3) as the burner assembly (200). The guard (210) thus protects a burner from contamination and/or contact while the burner assembly is not coupled to a reflector, which allows the burner to function properly while the burner assembly is in place with respect to a reflector. The particular configuration of the burner assembly (200) alone will be discussed with reference to FIGS. 2-1 through 2-3. The interaction of the burner assembly (200) and a reflector will be discussed with reference to FIGS. 3-1, through 3-3.

As best seen in FIG. 2-3, the burner assembly (200) generally includes a burner (220) coupled to a holder (230) by way of a header (235). The header (235) may provide electrical connections and support for the burner (220) while the holder (230) may allow a user to conveniently grasp or grab the burner assembly. In addition, the burner assembly (200) includes an indicator (225) on the proximal end of the holder (230). The indicator (225) shows the proper orientation of the burner assembly (200), such that a user is able to determine the proper orientation of the burner assembly (200) relative to a reflector.

The shape of the header (235) corresponds closely to the shape of an opening in a reflector. The close correspondence in size between the header (235) and the reflector opening allows for correct positioning and orientation of the burner assembly (200) with respect to the focal point of a reflector. The header (235) may be formed of any thermally stable material. Such materials include, without limitation, ceramic materials and high temperature plastics.

As introduced, the guard (210) is coupled to the holder (235) such that the guard (210) moves between the extended and retracted positions to thereby selectively cover or expose the burner (220). The guard (210) shown in the present exemplary embodiment includes a first retractable member (240) and a second retractable member (250). These members may be formed of any suitable thermally stable material, such as high temperature plastics and ceramic materials. Further, while a two-piece external guard has been introduced, those of skill in the art will appreciate that suitable guards may include any number of component parts. A lamp assembly will now be discussed in more detail with reference to a two-piece external guard.

FIGS. 3-1, 3-2, and 3-3 illustrate a schematic view of a lamp assembly (300) that includes the burner assembly (200) discussed above with reference to FIG. 2. Further, FIGS. 3-1, 3-2, and 3-3 illustrate the interaction between the burner assembly (200) and a reflector (305). The reflector (305) includes a reflective surface (310) and an opening (320). The reflective surface (310) has a generally elliptical profile, such as a parabolic or elliptical profile. As a result, the reflective surface (310) directs a substantial portion of light from the focal point out of the reflector (305).

The opening shown (320) includes a header receiving portion (330) and a guard receiving portion (340). The header receiving portion (330) is configured to interact with the distal end of the first retractable member (240), and the header engaging portion (330) is configured to interact with the header (235), as will now be discussed in more detail.

FIG. 3-1 illustrates the header assembly (200) in an initial position in which the guard (210) is fully extended. The guard (210) is held in this position by the interaction between the first and second retractable members (240, 250) and the second retractable member (250) and the holder (230). In particular, the first retractable member (240) has outer tapered surfaces (350) formed thereon. The second retractable member (250) has inner tapered surfaces (360) formed thereon that are configured to interact with the outer tapered surfaces (350) on the first retractable member (240).

When the first retractable member (240) is substantially fully extended relative to the second retractable member (250), these tapered surfaces are in contact with each other. The resulting frictional forces between the first retractable member (240) and the second retractable member (250) retain the first retractable member (240) in an extended position relative to the second retractable member (250).

The second retractable member (250) is also shown extended with respect to the header (230). More specifically, the second retractable member (250) also includes inner tapered surfaces (370) formed near the proximal end of the first retractable member (240). Corresponding outer tapered surfaces (380) are formed near the distal end of the holder (230). These surfaces are in contact with one another when the second retractable member (250) is extended relative to the holder (230). The resulting frictional forces caused by this contact thereby retain the second retractable member (250) extended relative to the holder (230).

As shown in FIG. 3-1, the distal end of the first retractable member (240) is configured to be received within the guard receiving portion (340). In particular, the perimeter of the distal end of the first retractable member (240) fits closely within perimeter of the guard receiving portion (340). According to the exemplary embodiment shown, the distal end of the first retractable member (240) is sized such that an interference fit exists when the first retractable member (240) is coupled to the guard receiving portion (340).

Further, the guard receiving portion (340) is configured to constrain or limit how far the first retractable member (240) extends. In particular, when the first retractable member (240) is advanced in the direction, the tip of the distal end of the first retractable member (240) comes into contact with the base of the header receiving portion, thereby limiting the advancement of the first retractable member (240).

As the burner (220) continues to be moved in the direction E, the frictional forces between the outer tapered surfaces (360) on the first retractable member (240) and the inner tapered surfaces (370) on the second retractable member (250) are overcome, thereby causing the first retractable member (240) to move relative to the second retractable member (250).

As shown in FIG. 3-2, as the burner (220) continues to move in the direction E, while the first retractable member (240) remains substantially stationary, the proximal end of the first retractable member (240) comes into contact with the proximal end of the second retractable member (250). Continued motion of the burner (220) and header (235) thereby overcomes the frictional forces between the inner tapered surfaces (370) and the outer tapered surfaces (380) on the holder (230), thereby causing the holder (230) to continue to move relative to both the first and second retractable members (240, 250), as is shown in FIG. 3-3.

As shown in FIG. 3-3, the burner (220) and header (235) continue to advance relative to the guard (210) until the header (235) comes into contact with the header receiving portion (330). Accordingly, the guard (210) is configured to protect the burner (220) from incidental and/or unintended contact by a user or other parts of the projector until the burner assembly (200) is coupled to the reflector (305).

Further, the guard (210) protects the burner (220) from accidental contact after the burner (220) is withdrawn from the reflector (305). As the burner (220) is withdrawn from the reflector (305), the burner assembly is moved in the direction R.

As previously discussed, an interference fit exists between the distal end of the first retractable member (240) and the guard receiving portion (340) while the first retractable member (240) is coupled thereto. As the burner (220) and header (235) are drawn in the direction R, the first retractable member (240) is retained in contact with the reflector (305).

This retention causes the outer tapered surfaces (350) on the first retractable member to be drawn in to contact with the inner tapered surfaces (360) and the inner tapered surfaces (370) on the second retractable member to come into contact with the outer tapered surfaces (380) of the holder (230). As the burner assembly (200) is thus drawn in the direction R, the guard (210) is extended and locked in position. With the guard (210) locked in an extended position, further movement of the burner assembly (200) in the direction R overcomes the frictional forces between the perimeter of the distal end of the first retractable member (240) and the guard receiving portion (340). Accordingly, the guard (210) is configured to be moved to an extended position as the guard (210) is withdrawn from reflector (305).

A two-piece guard has been shown and discussed above. Those of skill in the art will appreciate that any number of pieces may be used. For example, a unitary retractable guard may be used, as may a guard with more than two retractable members. Further, as discussed above, tapered surfaces may be utilized. Those of skill in the art will appreciate that any number of surfaces and/or devices may be used to allow one or more retractable members to selectively cover the burner (220). Further, the guard (210) that is generally external to the header (230) has been discussed. A guard may be included that is retracted into the header. One of such exemplary headers will be discussed in more detail below.

Burner Assembly with Internal Integrated Guard

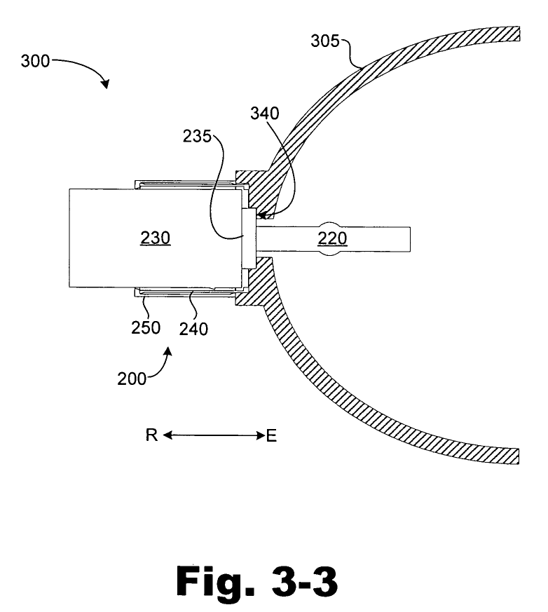

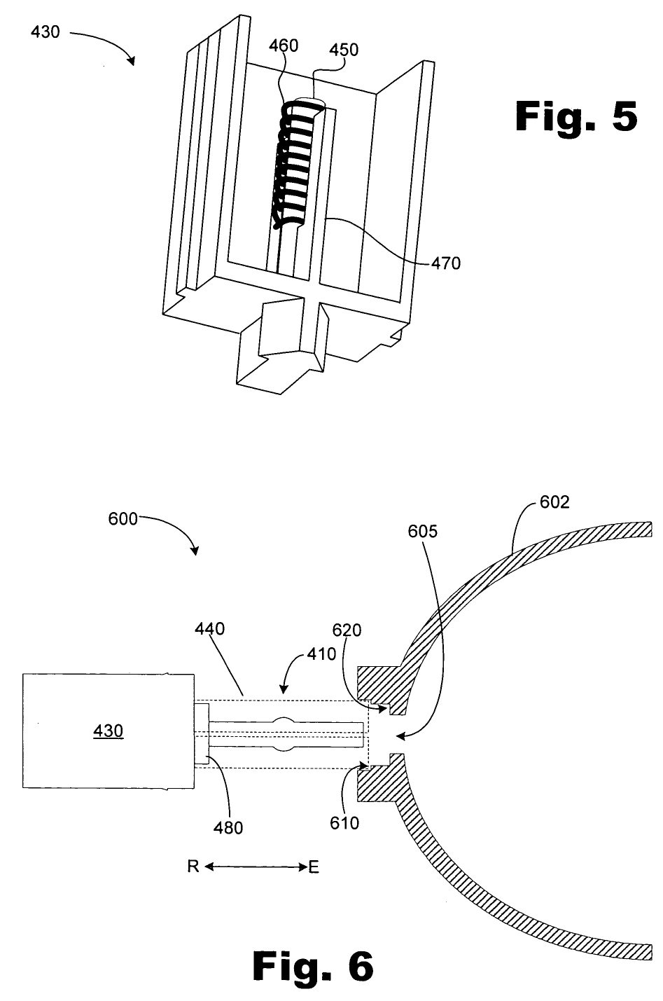

FIGS. 4-1, 4-2, and 4-3 illustrate a burner assembly (400) with an integrated internal guard (410). The burner assembly (400) includes a burner (420), a holder (430), and a header (435). The guard (410) is configured to move between an extended position (FIG. 4-1), an intermediate position (FIG. 4-2), and a retracted position (FIG. 4-3). The guard (410) is retracted into the holder (430). The guard (410) retracts into the holder (430) as the burner assembly (400) is coupled to a reflector, as will be discussed with reference to FIG. 6. Accordingly, the guard (410) is configured to protect the burner (420) when the burner (420) is not coupled to a reflector.

The guard (410) includes a plurality of opposing members (440). The opposing members shown are generally arcuate members. The guard (410) is made of a material that is stable at high temperatures. Examples of such materials include, without limitation, ceramic materials and high temperature plastics. Those of skill in the art will appreciate that the opposing members may be any shape. Further, the guard may be a single unitary member or may include any number of component members. The motion of these members (440) is opposed by biasing members that are internal to the holder (430). The internal configuration of the header (430) will now be discussed.

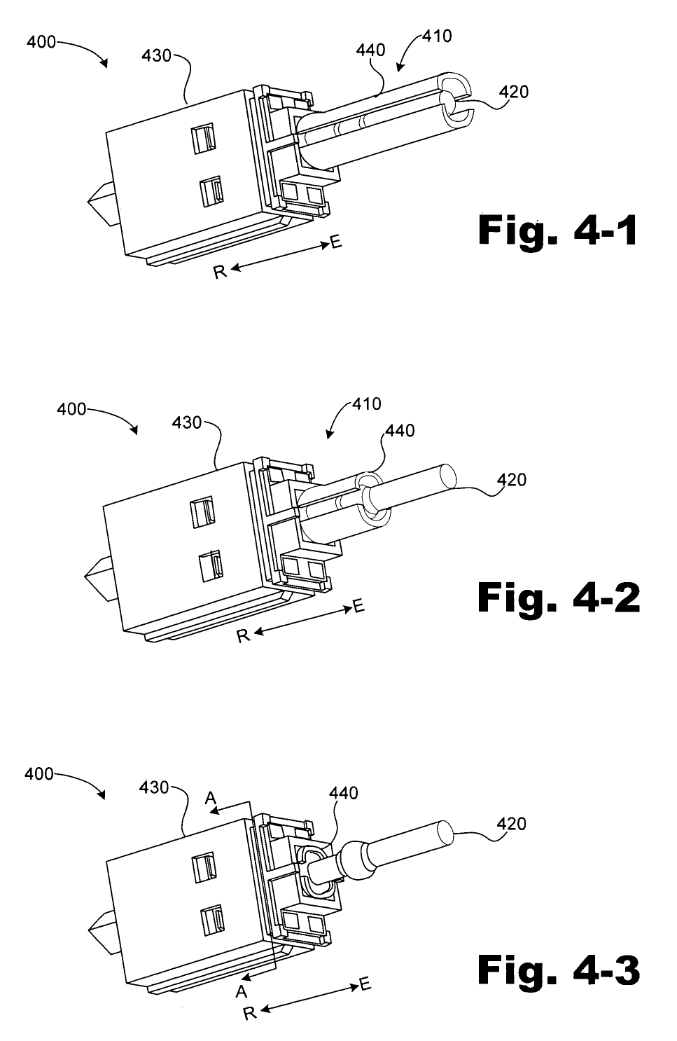

FIG. 5 illustrates a partial cross sectional view of the holder (430) as taken along section A-A. The holder (430) includes a spring guide (450) that supports a biasing member, such as spring (460). The holder (430) also includes opposing guide members (470) on either side of the spring (460) and spring guide (450). The configuration of the header (430) provides a pathway for the retraction of the guard (410). For example, as the burner assembly (400) is coupled to a reflector (600; FIG. 6), the guard (410; FIG. 4) is pushed in the direction R.

The spring (460) opposes the motion of the guard (410; FIG. 4) while the spaces between the spring guide (450) and the guide members (470) help ensure each member travels in the direction R. Accordingly, the holder (430) guides the retraction of the guard (410; FIG. 4). The header (430) also provides a biasing force to return the guard (410; FIG. 4) to an extended position when the burner assembly (400; FIG. 4) is no longer coupled to a reflector. The interaction of the burner assembly (400; FIG. 4) with an exemplary reflector will now be discussed.

A lamp assembly (600) having an exemplary reflector (602) is shown in FIG. 6. As seen in FIG. 6, the reflector includes an opening (605) with a guard receiving portion (610) and a header receiving portion (620). When the burner assembly (400, shown schematically) is coupled to the reflector (602) by pushing the burner assembly (400) in the direction E, the opposing members (440) of the guard come into contact with the guard receiving portion (610). This contact prevents further movement of the guard, such that as the burner assembly (400) continues to move in the direction E, the guard (410) is urged into the holder (430). This motion continues until the header (435) comes into contact with the header receiving portion (620) of the opening (605).

Accordingly, the guard (410) protects the burner (420, show schematically) as the burner assembly is coupled to the reflector (602). Further, as the burner assembly (400) is removed from the reflector (600), the spring (460) urges the guard (410) back to an extended position. Consequently, the guard (410) is able to protect the burner (420) when the burner assembly (400) is withdrawn from the reflector (600).

In conclusion, several exemplary burner assemblies are provided herein that provide retraction or extension of guards that are coupled thereto. Such guards may reduce inadvertent contact with the burner and a user and/or other parts of the projector both before and after the burner assemblies are coupled to reflectors. In addition, the guard may protect the user from touching hot surfaces when removing the lamp and provide protection of the glass surface for safe return of the assembly for recycling.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the disclosure be defined by the following claims.

What is claimed is:

1. A burner assembly, comprising:
a header;
a burner coupled to said header;
a holder coupled to said header; and
a guard coupled to said holder, said guard being configured to at least partially surround said burner and to retract in response to coupling said burner to a reflector.

2. The assembly of claim 1, wherein said guard is external to said holder.

3. The assembly of claim 2, wherein said guard comprises a plurality of retractable members.

4. The assembly of claim 3, wherein said guard comprises a first retractable member and a second retractable member.

5. The assembly of claim 4, wherein said first retractable member comprises a distal end configured to be interferingly coupled to a reflector opening.

6. The assembly of claim 4, wherein said first engaging member is configured to be selectively retained in an extended position relative to said second engaging member and said second engaging member is configured to be retained in an extended position relative to said holder.

7. The assembly of claim 6, and further comprising at least one retaining member formed on each of said first engaging member, said second engaging member and said header.

8. The assembly of claim 7, wherein said retaining members comprise tapered surfaces.

9. The assembly of claim 1, wherein said guard is internal to said holder.

10. The assembly of claim 4, wherein said first engaging member and said second engaging member comprise generally box type structures.

11. The assembly of claim 9, wherein said guard is configured to retract into said holder.

12. The assembly of claim 11, wherein said guard comprises opposing members.

13. The assembly of claim 12, wherein said opposing members comprise generally arcuate opposing members.

14. The assembly of claim 11, wherein said holder includes a spring guide and a spring coupled thereto and a plurality of guide members.

15. A lamp assembly, comprising:
a burner assembly including a header, a burner coupled to said header, a holder coupled to said header; and a guard coupled to said holder; and
a reflector; wherein said burner assembly is configured to be removably coupled to said reflector and said guard being configured to at least partially surround said burner and to retract in response to coupling said burner to said reflector.

16. The assembly of claim 15, wherein said reflector includes a guard receiving portion and a header receiving portion.

17. The assembly of claim 16, wherein said guard receiving portion is configured to receive a distal end of said guard therein such that an interference fit is established between said distal end of said guard and said guard receiving portion.

18. The lamp assembly of claim 15, wherein said burner assembly is configured to be used in a display system.

19. A display system, comprising:
a lamp assembly having a burner assembly, and a reflector, said burner assembly including a burner and a guard, said guard being configured to be selectively retracted when burner is coupled to said reflector; and
a projection assembly in optical communication with said lamp assembly.

20. The display system of claim 19, wherein said burner assembly is configured to be removably coupled to said reflector.

21. A method of forming a burner assembly, comprising:
coupling a burner to a header;
coupling said header to a holder;
coupling a guard to said holder, said guard being configured to at least partially surround said burner and to retract in response to coupling said burner to a reflector.

22. The method of claim 21, wherein coupling said guard to said holder comprises coupling said guard to an outer portion of said holder.

23. The method of claim 21, wherein coupling said guard to said holder comprises coupling said guard to an inner portion of said holder.

24. A burner assembly, comprising:
light generating means for generating light; and
retractable protecting means for retractably protecting said light generating means when said light generating means is coupled to reflecting means.

25. The assembly of claim 24, and further comprising holder means for holding said light generating means.

26. The assembly of claim 25, wherein said retractable protecting means is external to said holder means.

27. The assembly of claim 24, wherein said retractable protecting means is internal to said holder means.
